(19) United States
(12) Patent Application Publication
(10) Pub. No.: US 2015/0129529 A1
(43) Pub. Date: May 14, 2015

(54) MARINE LIFTING APPARATUS

(71) Applicant: Lee David Screaton, Missouri City, TX (US)

(72) Inventor: Lee David Screaton, Missouri City, TX (US)

(21) Appl. No.: 14/535,734

(22) Filed: Nov. 7, 2014

Related U.S. Application Data
(60) Provisional application No. 61/903,566, filed on Nov. 13, 2013.

(51) Int. Cl. B66C 13/06; B66C 23/52; B63B 27/10

(52) U.S. Cl. CPC B66C 13/063; B63B 27/10; B66C 23/52
USPC 212/277

(57) ABSTRACT

An apparatus is provided for use in combination with a sensor operative to detect heave motion. The apparatus comprises a main chassis, a drive assembly, a lifting column, a pinion, and control circuitry. The drive assembly is mounted to the main chassis and comprises a drive gear. The lifting column is translatably disposed in the main chassis and comprises a linear gear rack that runs along a longitudinal axis. The pinion is rotatably coupled to the rotation of the drive gear and engages with the linear gear rack such that rotation of the pinion is coupled to translation of the lifting column in the main chassis along the longitudinal axis. Finally, the control circuitry is operative to command the drive assembly to cause the lifting column to translate in the main chassis at least in part based on the heave motion detected by the sensor.

### FIELD OF THE INVENTION

The invention is generally related to the lifting of marine suspended loads, and, more particularly, to apparatus and methods for the active heave compensation.

### BACKGROUND OF THE INVENTION

Marine loads are suspended from shipboard cranes or winches when being moved from one location to another. These suspended loads are subjected to additional movement due to the action of the surrounding waves on the ship or vessel. Of the six degrees of motion (i.e., roll, pitch, yaw, heave, sway, and surge), it is the heave component that adds unwanted vertical movement to the load. Unwanted vertical motion frequently leads to damage to the load or the lifting arrangement, or improper placement of the load.

Conventional active heave compensation (AHC) typically utilizes power and instrumentation such as motion reference units (MRUs) to lengthen and shorten a lift wire or rope in response to heave motion. This kind of AHC is usually implemented utilizing a shipboard apparatus such as a crane-mounted or deck-mounted rotating winch, or a deck-mounted in-line cylinder. Nevertheless, while they are in widespread usage, such ship-mounted solutions may suffer from several disadvantages. Because these solutions work by lengthening and shortening the lift wire or rope, they may, for example, have difficulty with multi-part and multi-fall rigging arrangements. Moreover, for deep water applications, a ship-mounted solution can become out of sync with the subsea movement of the load if the lift wire or rope is bowed rather than being perfectly vertical. This can create a degree of slack in the lift wire or rope that can translate into reduced positional control at the load. It may also result in significant load intensification and “shock” loading, or even cause the load to unintentionally impact the ocean bottom.

There is, as a result, a need for alternative solutions for AHC that address the above-identified deficiencies.

### SUMMARY OF THE INVENTION

Embodiments of the invention address the above-identified needs by providing apparatus for AHC that may be placed between a lift wire or rope and the load being lifted. Advantageously, such embodiments require no significant installation on the vessel, and also work independently of the length of wire or rope deployed from the vessel.

Aspects of the invention are directed to an apparatus for use in combination with a sensor operative to detect heave motion. The apparatus comprises a main chassis, a drive assembly, a lifting column, a pinion, and control circuitry. The drive assembly is mounted to the main chassis and comprises a drive gear. The lifting column is translatably disposed in the main chassis and comprises a linear gear rack that runs along a longitudinal axis. The pinion is rotatably coupled to the rotation of the drive gear and engages with the linear gear rack such that rotation of the pinion is coupled to translation of the lifting column in the main chassis along the longitudinal axis. Finally, the control circuitry is operative to command the drive assembly to cause the lifting column to translate in the main chassis at least in part based on the heave motion detected by the sensor.

Additional aspects of the invention are directed to a method for reducing heave motion in a load suspended from a vessel. The method comprises the steps of: (a) providing a sensor, the sensor operative to detect heave motion; (b) suspending an apparatus from the vessel; and (c) suspending the load from a lifting column of the apparatus. In addition to the lifting column, the apparatus comprises a main chassis, a drive assembly, a pinion, and control circuitry. The drive assembly is mounted to the main chassis and comprises a drive gear. The lifting column is translatably disposed in the main chassis and comprises a linear gear rack that runs along a longitudinal axis. The pinion is rotatably coupled to the rotation of the drive gear and engages with the linear gear rack such that rotation of the pinion is coupled to translation of the lifting column in the main chassis along the longitudinal axis. Finally, the control circuitry is operative to command the drive assembly to cause the lifting column to translate in the main chassis at least in part based on the heave motion detected by the sensor.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of an AHC apparatus in accordance with an illustrative embodiment of the invention;

FIG. 2 shows a partially-broken, exploded perspective view of the FIG. 1 AHC apparatus;

FIG. 2a shows an enlarged perspective view of the region indicated in FIG. 2;

FIG. 3 shows another exploded perspective view of the FIG. 1 AHC apparatus;

FIG. 4 shows a block diagram of various electronic and electrically-actuated components in the FIG. 1 AHC apparatus;

FIG. 5 shows an elevational view of the FIG. 1 AHC apparatus suspended from a vessel;

FIGS. 6 and 7 show the FIG. 1 AHC apparatus reacting to different heave conditions; and

FIG. 8 shows a perspective view of an alternative AHC apparatus in accordance with an illustrative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

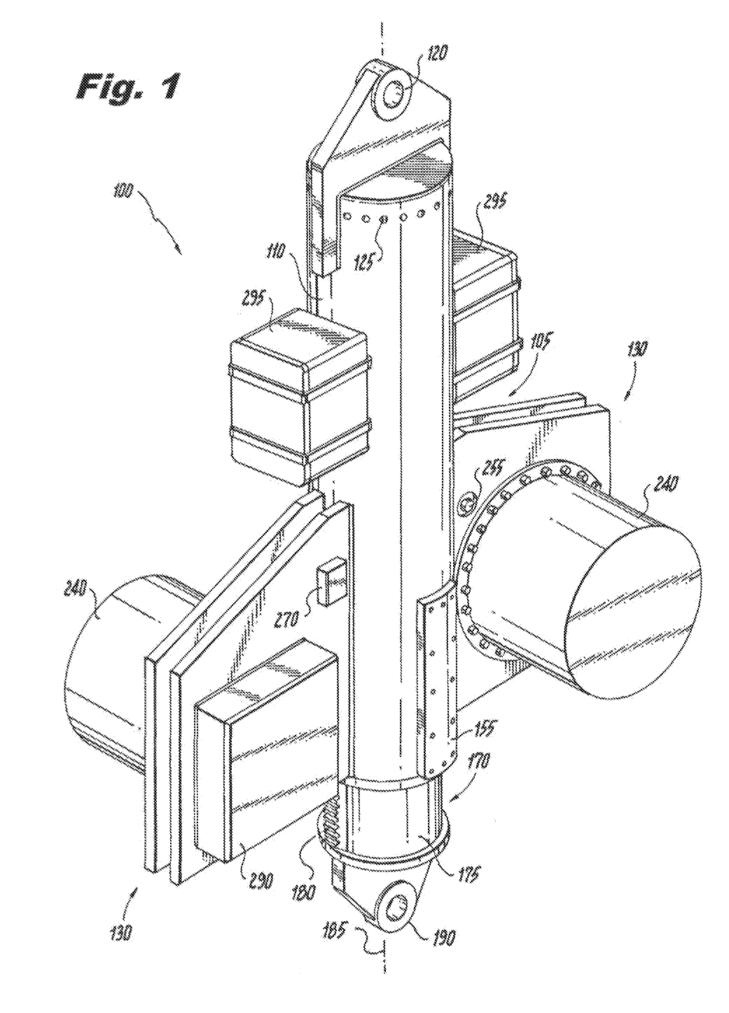

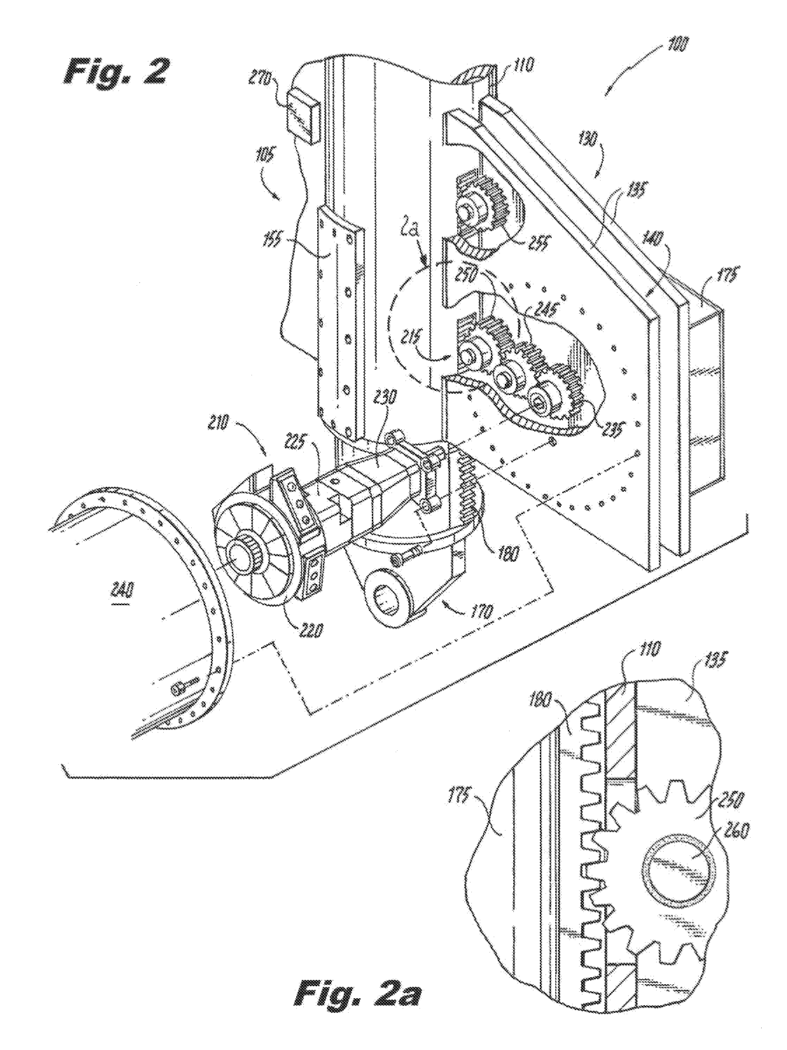

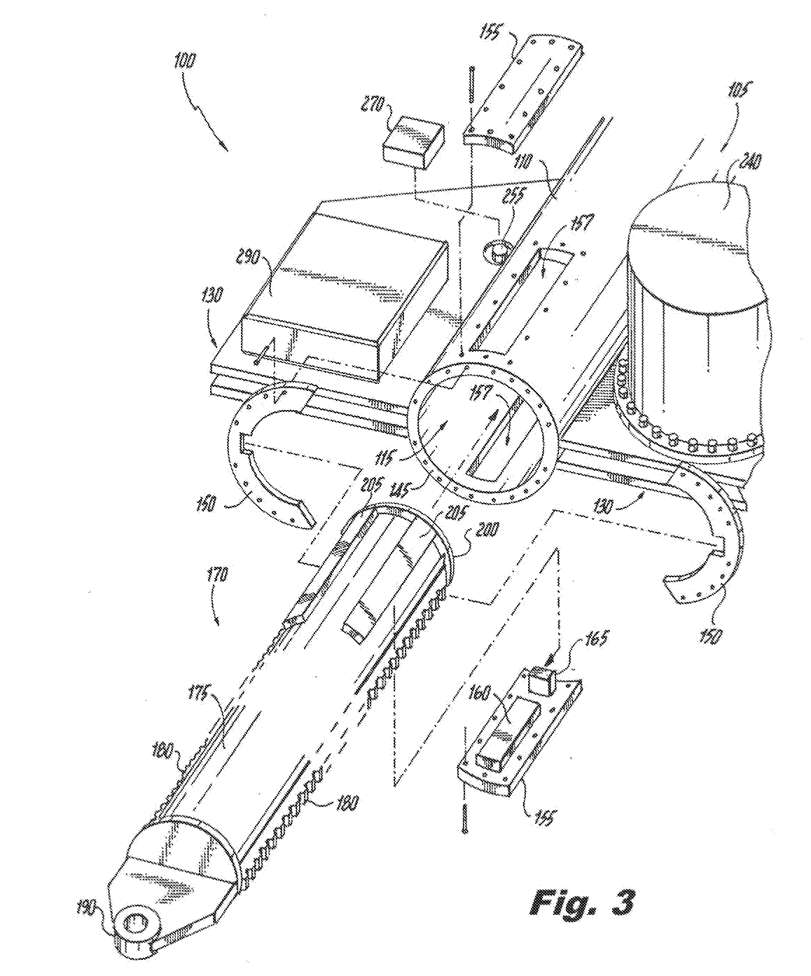

FIGS. 1-3 show aspects of an AHC apparatus 100 in accordance with an illustrative embodiment of the invention. FIG. 1 shows a perspective view of the illustrative AHC apparatus 100, while FIG. 2 shows a partially-broken, exploded perspective view, and FIG. 3 shows another exploded perspective view. FIG. 2a shows an enlarged perspective view of the region indicated in FIG. 2.

In the AHC apparatus 100, a main chassis 105 includes a cylindrical case 110 that defines a cylindrical volume 115 therein. An upper attachment ring 120 is attached to the top of the cylindrical case 110 proximate to a set of vent holes 125. On opposite sides of the cylindrical case 110, two mounting extensions 130 project from the cylindrical case 110 in the manner of wings. Each of the mounting extensions 130 is defined by a respective pair of parallel sidewalls 135. Each of the pairs of parallel sidewalls 135 defines a respective gear space 140 therebetween.

The main chassis 105 further defines a lower flange 145, to which is attached two removable circular plate halves 150. At the same time, a pair of removable side plates 155 is also attached to the cylindrical case 110 at respective rectangular openings 157. Each of the removable side plates 155 defines a respective side plate rub strip 160 and a side plate shear stop 165. The side plate rub strips 160 and the side plate shear stops 165 project into the cylindrical volume 115 of the cylindrical case 110 when the removable side plates 155 are attached thereto.

A lifting column 170 is translatably disposed within the cylindrical volume 115 of the main chassis 105. The lifting column 170 defines a cylindrical body 175. A pair of linear gear racks 180 are attached to opposite sides of the cylindrical body 175 and run along a longitudinal axis 185 of the AHC apparatus 100. A lower attachment ring 190 is mounted to the bottom of the cylindrical body 175, while an upper shear plate 200 is attached to the top of the cylindrical body 175. Several lifting column rub strips 205 are also attached to the cylindrical body 175 of the lifting column 170.

Each of the mounting extensions 130 supports a respective drive assembly 210 and a respective set of gears 215. Only a representative one of the drive assemblies 210 and only a representative one of the sets of gears 215 are detailed in FIG. 2, but these elements are duplicated on the other mounting extension 130. Each drive assembly 210 includes a respective motor 220 that is attached to a respective brake 225, which is, in turn, attached to a respective gearbox 230. Each of the gearboxes 230 is attached to one of the mounting extensions 130 and terminates in a respective drive gear 235. The drive gears 235 are located in the gear spaces 140 between the pairs of parallel sidewalls 135 of the mounting extensions 130. A respective drive assembly cover 240 covers each of the drive assemblies 210 and isolates its drive assembly 210 from surrounding seawater.

In addition to a respective drive gear 235, each of the sets of gears 215 includes a respective transfer gear 245, a respective pinion 250, and a respective idler gear 255. The transfer gears 245, the pinions 250, and the idler gears 255 are supported in the gear spaces 140 by bearings 260 that pass therethrough and are supported by the parallel sidewalls 135 of the mounting extensions 130. The bearings 260 are preferably of the self-lubricating type. The transfer gears 245 are meshed with the drive gears 235 and the pinions 250. The pinions 250 pass through windows in the cylindrical case 110 and mesh with the linear gear racks 180 on the lifting column 170. The idler gears 255 stand apart from the other gears and are also meshed with the linear gear racks 180 through additional windows in the cylindrical case 110.

In addition to the several elements set forth above, the AHC apparatus 100 further comprises a number of electronic components, which are isolated from seawater via various water-proof enclosures. A position encoder 265 occupies a position encoder box 270 located over one of the idler gears 255. At the same time, the AHC apparatus 100 also includes control circuitry 275, a heave sensor 280, and a kinetic energy recovery system (KERS) 285, which variously occupy a pair of junction boxes 290. The junction boxes 290 are disposed on the mounting extensions 130 opposite the drive assemblies 210 and the drive assembly covers 240. Batteries 292 are located in a pair of strap-on battery pods 295 that are disposed on opposing sides of the cylindrical case 110 above the mounting extensions 130. Wiring among these various components is also present in the AHC apparatus 100, but it is not explicitly shown in the figures. Wires, for example, may span between the position encoder box 270 and the junction boxes 290, and between the battery pods 295 and the junction boxes 290. Wires may further span between the two junction boxes 290, and between the junction boxes 290 and the motors 220 and the brakes 225. The wires may be enclosed in waterproof conduits where they would be exposed to seawater if left unprotected.

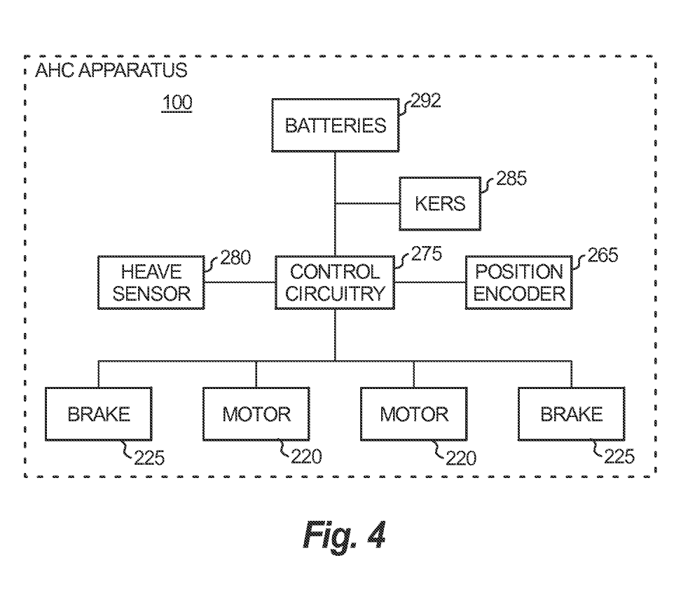

FIG. 4 shows a block diagram of the various electronic and electrically-actuated components in the AHC apparatus 100 and the manner in which they cooperate. As the name would suggest, the heave sensor 280 is operative to detect heave motion at the sensor. The heave sensor 280 may, for example, comprise an MRU. The position encoder 265 preferably comprises a rotary encoder. The rotary encoder may be coupled to the rotation of the underlying idler gear 255 via a rigid or flexible shaft. The position encoder 265 is thereby operative to report rotation of the idler gear 255, which may be converted into the position of the lifting column 170 in the main chassis 105.

The control circuitry 275 receives signal inputs from the heave sensor 280 and the position encoder 265, and utilizes this information to drive the motors 220 and brakes 225 so as to cause the lifting column 170 to translate in the main chassis 105. The control circuitry 275 may comprise one or more data processing portions, one or more memory portions, and one or more input/output portions. The control circuitry 275 may, for example, be configured in the form of one or more microprocessor-controlled programmable logic controllers (PLCs). Instructions for the PLCs may be in the form of firmware and/or software stored in nonvolatile memory.

Power is supplied to the control circuitry 275 and ultimately to the motors 220 and the brakes 225 via the batteries 292 in the battery pods 295. At the same time, the KERS 285 stores energy developed by the motors 220 when the lifting column 170 translates downward in the main chassis 105 in reaction to the force of gravity. Subsequently, the KERS 285 supplies this stored energy upon demand.

Once understood from the teachings herein, the various elements forming the above-described AHC apparatus 100 may be formed from conventional materials utilizing conventional manufacturing techniques, or alternatively, obtained commercially. The main chassis 105, the lifting column 170, and their associated static appendages, for example, are preferably formed from a metal such as, but not limited to steel, with a protective paint or coating suitable for marine use. When not available commercially, these components may be custom manufactured utilizing conventional metal forming techniques, which will be familiar to one skilled in the relevant metal forming arts. Gaskets may be utilized to create watertight seals as required.

At the same time, the sets of gears 215, the motors 220, the brakes 225, and the gearboxes 230 may be obtained commercially. Suitable gears 215 and the gearboxes 230 may, for example, be obtained from HMK Automation & Drives (Cheshire, UK). The motors 220, on the other hand, preferably comprise axial flux motors, which are typically smaller and lighter than conventional electric motors. Suitable motors 220 are available from, for example, Ashwoods Automotive (Exeter, UK). The brakes 225 are preferably electromagnetic brakes, which, for safety, are configured to apply a braking force when their control signal is lost. Suitable brakes 225 are available from, as just one example, Chr. Mayr GmbH & Co. (Mauerstetten, Germany).

The electronic components may also be sourced commercially. A suitable MRU for the heave sensor 280 may be sourced from, for instance, Kongsberg Maritime, (Kongsberg, Norway). The batteries 292 may be of the lithium-ion type used in electric automobiles, and may be obtained from, for example, A123 Systems, LLC (Livonia, MI, USA). The KERS 285 may be obtained from, for instance, GKN Land Systems (Worcestershire, UK). Lastly, a suitable rotary encoder for the position encoder 265 and suitable components for the control circuitry 275 may be sourced from, for example, Advanced Micro Controls Inc. (Terryville, Conn., USA) and Scantrol (Bergen, Norway). Advantageously, once the unique functionality of the AHC apparatus 100 is understood from the teachings herein, the programming of the control circuitry 275 to support the desired functions will be well within the skill of one having ordinary skill in the relevant arts. Configuring and programming PLCs is described in a number of readily available references, including, for example, W. Bolton, Programmable Logic Controllers, Fifth Edition, Newnes, 2009; and F. Petruzella, Programmable Logic Controllers, Fourth Edition, McGraw-Hill Science/Engineering/Math 2010, which are both hereby incorporated by reference herein.

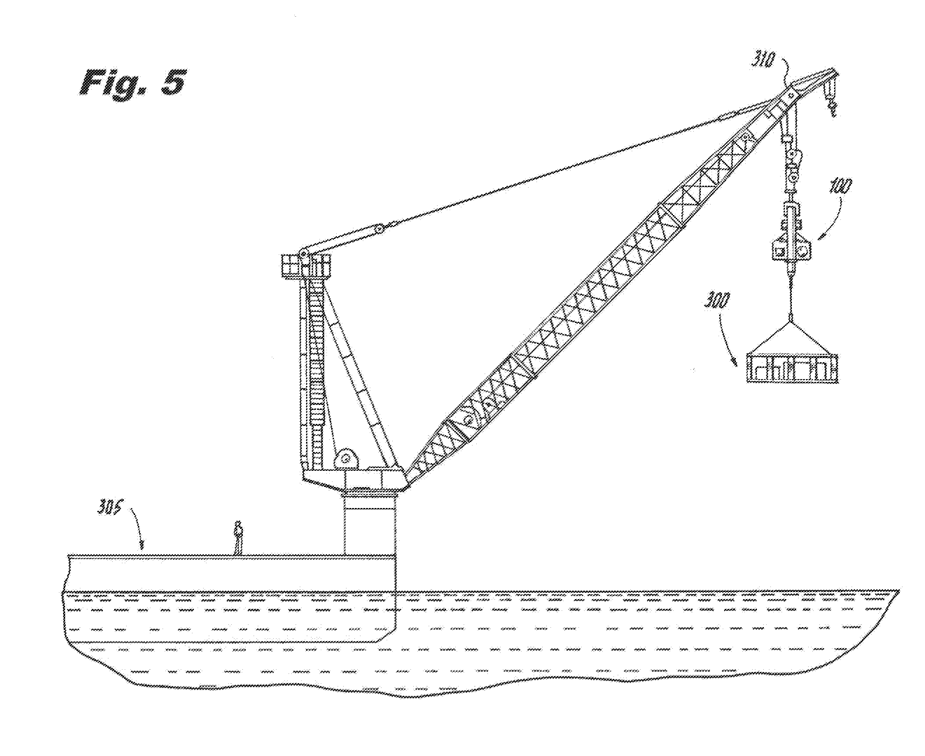

So configured, the AHC apparatus 100 may be made to reduce the heave motion of a load suspended from a vessel. FIG. 5 shows an elevational view of the AHC apparatus 100 configured to perform this function for a load 300 suspended from a vessel 305. The upper attachment ring 120 of the main chassis 105 is suspended from lifting rigging 310 on the vessel. The load 300 is suspended from the lower attachment ring 190 of the lifting column 170.

While active, the heave sensor 280 detects the heave motion at the main chassis 105 and reports this motion to the control circuitry 275. The control circuitry 275, in turn, commands the motors 220 and the brakes 225 to cause the lifting column 170 to move proportionally in a direction opposite to the detected heave motion. When the lifting column 170 needs to be translated upward in the main chassis 105, for example, the control circuitry 275 commands the brakes 225 to release and the motors 220 to rotate the drive gears 235 such that the lifting column 170 rises at the desired rate. When the lifting column 170 needs to be translated downward, the brakes 225 are released to the extent necessary to allow gravity to pull the lifting column 170 downward at the desired rate. Optionally, the motors 220 may also be commanded to power the lifting column 170 downward. If the heave motion stops and the lifting column 170 doesn't need to move, the brakes 225 are applied sufficiently to hold the lifting column 170 in place.

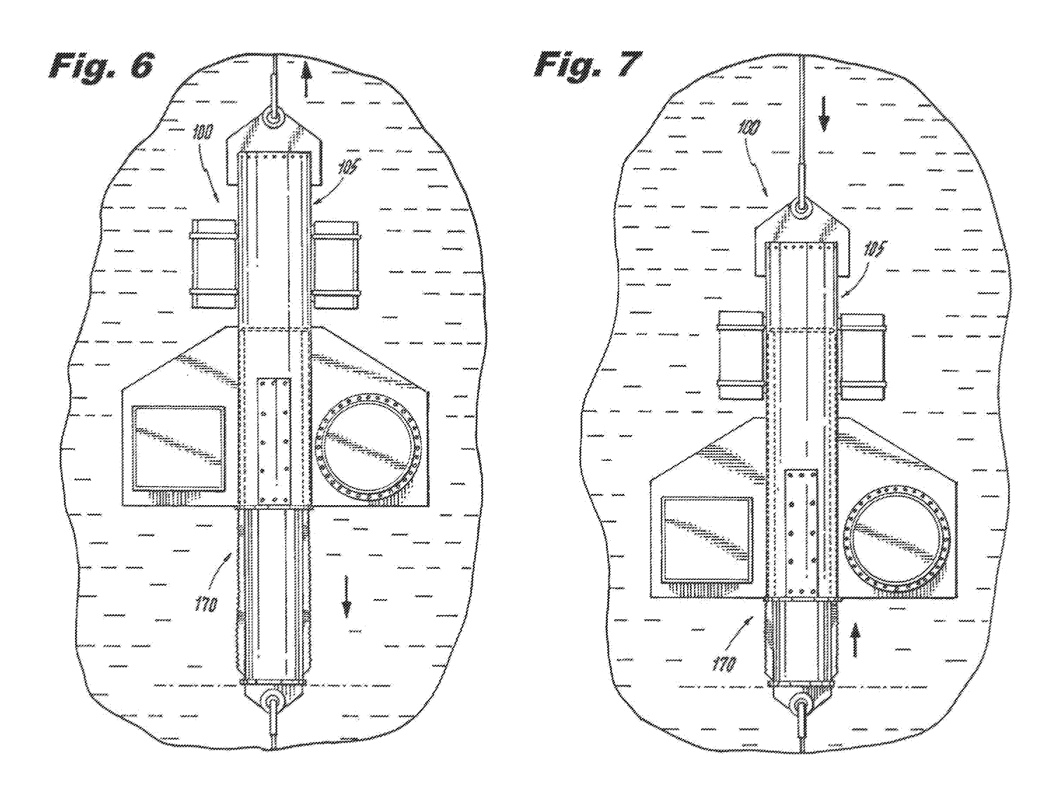

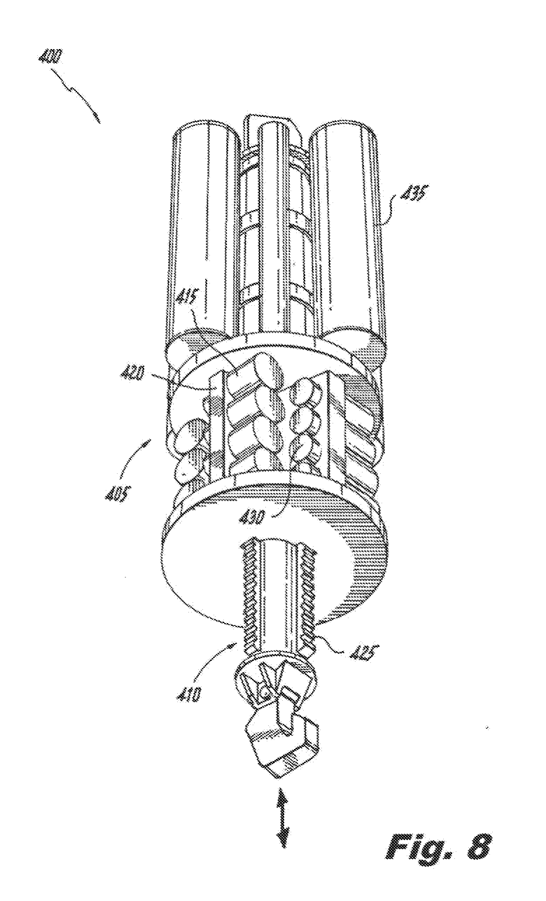

This functioning of the AHC apparatus 100 is illustrated in the elevational views in FIGS. 6 and 7. In FIG. 6, the vessel 305 and the main chassis 105 are rising upward due to heave motion. The control circuitry 275 therefore causes the lifting column 170 to proportionally translate downward in the main chassis 105. In FIG. 7, the opposite motion is occurring. That is, the vessel 305 and the main chassis 105 are dropping downward due to heave motion and the control circuitry 275 is causing the lifting column 170 to be proportionally translated upward in the main chassis 105. The net effect is that the lifting column 170 and the load 300 remain relatively stationary in space while the remainder of the AHC apparatus 100 and the vessel 305 rise and drop due to sea motion. Note the common datum indicated on FIGS. 6 and 7.

During operation in the water, the vent holes 125 allow seawater to enter and exit the cylindrical volume 115 of the main chassis 105 so that pressures across the lifting column 170 remain equalized as it translates. At the same time, the sets of gears 215 and the circular plate halves 150 (with their cutouts) act to keep the lifting column 170 aligned in the main chassis 105, while the side plate rub strips 160 and the lifting column rub strip 205 act to reduce friction therebetween. If power is unexpectedly lost, the brakes 225 will activate and keep the lifting column 170 in place in the main chassis 105. If the brakes 225 are also compromised, the lifting column 170 will only translate downward in the main chassis 105 to the point where the upper shear plate 200 meets the side plate shear stops 165. The upper shear plate 200 and the side plate shear stops 165 thereby cooperate to create a mechanical failsafe. That is, the lifting column 170 will not depart the remainder of the AHC apparatus 100 even if several systems fail simultaneously.

The AHC apparatus 100 provides several advantages. Fundamentally, canceling any heave motion at a load allows that load to be lowered without the load repeatedly crashing into the seabed. Moreover, canceling the heave motion allows the load to be more precisely positioned on the seabed.

Positioning an AHC system near the load rather than aboard the vessel also provides several benefits. It is common for lifting rigging aboard vessels to include multi part/fall rigging. When utilizing multi part/fall rigging, a wire or rope from a winch aboard the vessel does not directly attach to the load, but instead travels through various sheaves so as to increase the lift capacity of the rigging arrangement. For example, a two-part or two-fall rigging arrangement has the wire or rope travel from the winch to a hook, through a sheave at the hook, back to the crane tip, through a sheave at the crane tip, and then finally back to the hook. This arrangement effectively doubles the lifting capacity of the system, thereby allowing the winch and wire or rope to be kept to manageable sizes. Nevertheless, conventional heave compensation systems aboard vessels that function by extending or shortening the wire or rope in response to heave have their effect reduced by 50% for each part/fall. Any more than two-part/fall rigging tends to render a typical AHC system ineffective. In contrast, embodiments in accordance with aspects of the invention suffer no impacts due to multi-part/fall rigging, as these AHC apparatus may be located at a point past the rigging and they do not rely on the manipulation of wire or rope length.

At the same time, when a typical vessel-based AHC system is used as part of deep water operations, the lifting arrangement can experience instability and synchronization issues as the lifting wire or rope is likely not to be perfectly straight. Shortening and extending the wire or rope may therefore only serve to remove the curve in the wire. Embodiments of the invention avoid these problems by being placed at the load, and so suffer no impact due to the wire or rope being straight or otherwise. There are passive heave compensation systems that offer this function. However embodiments of the invention provide active heave compensation due to their use of motors that can be powered by stored energy systems such as batteries.

The use of motors in the AHC apparatus 100, as opposed to crane-mounted or deck-mounted rotating winches or a deck-mounted in-line cylinders for AHC, also provides several advantages. The use of motors, for example, avoids typical problems associated with winches such as inertia of the drum, tension control between a traction winch and a storage winch, etc. Moreover, the motors can be electrical, in which case the arrangement lends itself to subsea operations where the motors can be driven locally by batteries or similar energy storage systems. Electrical systems offer the advantage of mitigating any pollution effects due to loose hoses, etc. that are applicable to a hydraulic based system. At the same time, having the AHC apparatus be self-powered aids portability and reduces the need for significant installation on a vessel before use. Lastly, motors are typically lighter than the equivalent load bearing cylinders. Embodiments in accordance with aspects of the invention may therefore allow loads to be handled more efficiently than equivalent cylinder-based systems.

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

For example, while the above-described AHC apparatus 100 utilizes two drive assemblies 210, alternative embodiments may utilize more than two drive assemblies. FIG. 8 shows a perspective view of an alternative AHC apparatus 400 in accordance with an illustrative embodiment of the invention. Like the AHC apparatus 100, the alternative AHC apparatus 400 comprises a main chassis 405 with a lifting column 410. However, unlike the AHC apparatus 100, the alternative AHC apparatus 400 utilizes sixteen drive assemblies 415 with sixteen motors to translate the lifting column 410 within the main chassis 405 as opposed to just two drive assemblies with two motors. The sixteen drive assemblies 415 are arranged in four banks to four attachment extensions 420 that project from the main chassis 405 at 90-degree relative orientations. Correspondingly, the lifting column 410 is fitted with four linear gear racks 425 instead of just two. Junction boxes 430 and battery pods 435 hold electronics and batteries.

While sixteen drive assemblies 415 are shown in the alternative AHC apparatus 400, additional embodiments of the invention may utilize a greater or smaller number. Alternative embodiments may, as just a few examples, utilize 4, 8, 12, or even 20 drive assemblies without a fundamental redesign of the system or components. AHC apparatus in accordance with aspects of the invention are therefore scalable. As would be predicted, a greater number of drive assemblies increases the load capacity of an AHC apparatus at the cost of greater power consumption, greater weight, and greater cost. A two-motor version with two 5 kilowatt (kW) axial flux motor may, as just an illustration, be capable of handling two metric tons (Te), while a sixteen-motor version with 200 kW motors may be able to accommodate 400 Te. These numbers, however, are merely illustrative and not intended to limit the scope of the invention.

In addition, alternative embodiments of the invention may, as another example, not utilize battery power, but instead may be supplied with power from a vessel. Such power may be supplied by an umbilical cable spanning between the vessel and the AHC apparatus, for example. In even other embodiments, power may be supplied at the AHC apparatus by an alternative power solution such as a fuel cell.

It should also be recognized that, while the sets of gears 215 in the illustrative, non-limiting AHC apparatus 100 utilize three respective gears to couple each of the drive assemblies 210 to the lifting rack 170, alternative embodiments may utilize very different arrangements of gears for performing that function. Instead of utilizing one of each type of gear, alternative embodiments may, for example, comprise a respective set of gears for a given drive assembly that comprises two or more drive gears, two or more transfer gears, two or more pinions, or some combination thereof. Thus, it is reinforced that the arrangement of gears in the illustrative AHC apparatus 100 is exemplary only and is non-limiting with respect to the scope of the present invention.

In even other embodiments, the main chassis and the lifting column may not be cylindrical, but may have alternative shapes. In one or more embodiments, for example, a main chassis and lifting column may be square tubular in the manner of telescopic sections used in many cranes. At the same time, while the various electronic components in the illustrative AHC apparatus 100 (e.g., the heave sensor 280, the control circuitry 275, and the position encoder 265) occupy the junction boxes 175, alternative embodiments in accordance with aspects of the invention may locate their electronics elsewhere, such as within the lifting column itself. In even other embodiments, some or all of the electronic components for an AHC apparatus may be located remote from the remainder of the AHC apparatus, such as on a vessel. Data and instructions may then be communicated between the remote electronic components and the remainder of the AHC apparatus via an umbilical cable or other communication medium (e.g., by radio). Thus, an “apparatus” falling within the scope of the invention need not be unified in structure, but may be distributed in space.

Finally, while brakes and a KERS are used in the illustrative AHC apparatus 100, it will be recognized that these elements are optional, and, if desired, may be eliminated. With respect to eliminating the brakes for example, embodiments falling within the scope of the claims may rely solely on the motors for controlling the motion of their lifting columns.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An apparatus for use in combination with a sensor operative to detect heave motion, the apparatus comprising:
a main chassis;
a drive assembly, the drive assembly mounted to the main chassis and comprising a drive gear;
a lifting column, the lifting column translatably disposed in the main chassis and comprising a linear gear rack that runs along a longitudinal axis;
a pinion, the pinion rotatably coupled to the rotation of the drive gear and engaged with the linear gear rack such that rotation of the pinion is coupled to translation of the lifting column in the main chassis along the longitudinal axis; and
control circuitry, the control circuitry operative to command the drive assembly to cause the lifting column to translate in the main chassis at least in part based on the heave motion detected by the sensor.

2. The apparatus of claim 1, wherein the drive assembly comprises an electric motor.

3. The apparatus of claim 1, wherein the drive assembly comprises an electromagnetic brake.

4. The apparatus of claim 1, wherein the drive assembly comprises a gearbox.

5. The apparatus of claim 1, wherein the main chassis defines a mounting extension with two substantially parallel sidewalls defining a space therebetween.

6. The apparatus of claim 5, wherein the drive assembly is mounted to the mounting extension such that the drive gear occupies a portion of the space.

7. The apparatus of claim 5, wherein the pinion occupies a portion of the space.

8. The apparatus of claim 1, wherein the lifting column terminates in a hook or a ring.

9. The apparatus of claim 1, wherein the control circuitry is operative to command the drive assembly to cause the lifting column to translate in the main chassis in a direction opposite to the heave motion detected by the sensor.

10. The apparatus of claim 1, further comprising a transfer gear, the transfer gear coupling rotation of the pinion to rotation of the drive gear.

11. The apparatus of claim 1, wherein the sensor comprises a motion reference unit.

12. The apparatus of claim 1, wherein the sensor is mounted to the apparatus.

13. The apparatus of claim 1, further comprising a battery.

14. The apparatus of claim 1, further comprising a kinetic energy recovery system.

15. The apparatus of claim 1, further comprising:
a second drive assembly, the second drive assembly mounted to the main chassis and comprising a second drive gear;
a second linear gear rack, the second linear gear rack forming part of the lifting column and running along the longitudinal axis; and
a second pinion, the second pinion rotatably coupled to the rotation of the second drive gear and engaged with the second linear gear rack such that rotation of the second pinion is coupled to translation of the lifting column in the main chassis along the longitudinal axis;
wherein the control circuitry is operative to command the second drive assembly to cause the lifting column to translate in the main chassis at least in part based on the heave motion detected by the sensor.

16. The apparatus of claim 1, further comprising a plurality of additional drive assemblies.

17. The apparatus of claim 1, further comprising a shear stop, the shear stop protruding into the main chassis and mechanically limiting an extent of translation of the lifting column in the main chassis.

18. The apparatus of claim 1, further comprising:
a vessel;
lifting rigging, the lifting rigging attached to the vessel; and
a load;
wherein the apparatus is suspended from the lifting rigging, and the load is suspended from the lifting column.

19. The apparatus of claim 18, wherein the apparatus is operative to reduce heave motion of the load relative to the heave motion detected by the sensor.

20. A method for reducing heave motion in a load suspended from a vessel, the method comprising the steps of:
(a) providing a sensor, the sensor operative to detect heave motion;
(b) suspending an apparatus from the vessel, the apparatus comprising:
(i) a main chassis;
(ii) a drive assembly, the drive assembly mounted to the main chassis and comprising a drive gear;
(iii) a lifting column, the lifting column translatably disposed in the main chassis and comprising a linear gear rack that runs along a longitudinal axis;
(iv) a pinion, the pinion rotatably coupled to the rotation of the drive gear and engaged with the linear gear rack such that rotation of the pinion is coupled to translation of the lifting column in the main chassis along the longitudinal axis; and
(v) control circuitry, the control circuitry operative to command the drive assembly to cause the lifting column to translate in the main chassis at least in part based on the heave motion detected by the sensor; and
(c) suspending the load from the lifting column.
